(19) United States
(12) Patent Application Publication
(10) Pub. No.: US 2003/0046504 A1
(43) Pub. Date: Mar. 6, 2003

(54) ROM-data read-protection-cancellation device with improved access authority check

(76) Inventor: Terukazu Yusa, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/193,270

(22) Filed: Jul. 12, 2002

(30) Foreign Application Priority Data
Aug. 29, 2001 (JP) 2001-260000

(51) Int. Cl. G06F 12/00; G06F 12/14

(52) U.S. Cl. 711/163; 711/102; 711/156

(57) ABSTRACT

A person who would like to cancel read-protection of ROM data inputs an “address,” an “information length,” and an “input information part.” The input information part should be a part of a data file stored in the ROM. The input address corresponds to the starting address of the information part in the ROM. The input information length is the length of the input information part. A ROM-data read-control circuit reads a stored information part with the input information length from an area or areas in the ROM with the input starting address. Next, the ROM-data read-control circuit compares the stored information part with the input information part. The ROM-data read-control circuit cancels the read-protection when the input information part coincides with the stored information part.

### BACKGROUND OF THE INVENTION

1. Field of the Invention

The present invention relates to a ROM-data read-protection-cancellation device wherein read-protection of ROM data is canceled if an operator knows an information part stored in a ROM (read-only memory) correctly.

2. Description of Background Art

Usual microcomputer is provided with a ROM storing programs for controlling operations of the microcomputer and other data that should be stored permanently or semipermanently. In general, it is preferable that programs and other data cannot be read out in order to prevent data from being copied. On the other hand, the manufacturer of a microcomputer and the producer of a program sometimes would like to read and check a program stored in a ROM for failure analysis, operational test of the ROM, or other inspections.

In order to satisfy the above-mentioned conflicting demands, a technique is developed wherein a protection code that controls hardware is stored in a specific area of a ROM. For example, a protection code scheme that employs codes for representing the protection state or not may be utilized. If the protection code represents the protection state, the microcomputer hardware is disabled for reading predetermined data in the ROM without using a special instrument, such as an LSI tester in order to prohibit data from reading by users.

Another protection code scheme that employs codes for representing protection levels may also be utilized. If the protection code represents a high protection level, data cannot be read absolutely. If the code represents a low protection level, only a special instrument, such as an LSI tester is allowed to read the data.

JP-A-4-219823 discloses a technique wherein a secret code is stored in a specific area of a ROM. In accordance with this technique, when both of address corresponding to the specific area and the secret code stored therein are properly input into the microcomputer by a person, data in the ROM can be read and served for inspections. When the input address and/or the secret code are wrong, data cannot be read, so as to be protected.

JP-A-7-105169 discloses a technique wherein a program information part stored in a program memory can be checked if the program information part and address information part that should correspond to the program information part are properly input. In accordance with this technique, when the input address information part does not coincide with the address information part (corresponding to the address inside the memory) generated on the basis of clock pulses, data is prohibited from being read from the program memory. If the input address information part coincides with the address information part prepared inside the microcomputer, the input program information part is compared with the program information part stored in the area within the program memory corresponding to the address information part.

If the program information parts coincide with each other, next address information part and program information part are checked similarly. However, if the program information parts do not coincide with each other, the stored program information part in the program memory is output at a specific period. This technique provides a merit that persons knowing relations between all program information parts and addresses can check the program entirely. It is extremely difficult for other persons to check or acquire the stored program.

However, the conventional ROM-data read-protection-cancellation devices or methods have drawbacks that protection is insufficient or protection-cancellation exhibits less flexibility in use, as will be described below.

With regard to the technique wherein a protection code is stored in a specific area of a ROM, when the protection code represents the low protection level, data can be read with an LSI tester, and so on. Although this is convenient for failure analysis, operational test of the ROM, or other inspections, this means that whoever has an LSI tester or special instrument can obtain the stored data. In addition, it is troublesome to store the special protection code in the ROM for controlling the protection status. It is also troublesome to determine or set the protection level. Furthermore, since one or more areas must be reserved for storing the protection code, areas for storing programs or other data are limited.

In connection with the technique disclosed in JP-A-4-219823, a third party can obtain his or her target data if he or she knows the secret code and the address corresponding to the specific area where the secret code is stored.

Concerning the technique disclosed in JP-A-7-105169, even the manufacturer of a microcomputer and the producer of a program cannot check the whole program unless he or she has input all program information parts and all addresses.

### SUMMARY OF THE INVENTION

It is therefore an object of the present invention to provide a ROM-data read-protection-cancellation device wherein the assurance of ROM-data read-protection is high while the flexibility in use is improved.

In accordance with the present invention, there is provided a ROM-data read-protection-cancellation device, which cancels read-protection of ROM data if an operator knows an information part stored in a ROM correctly. The ROM-data read-protection-cancellation device includes a reading element and a comparing element. The reading element reads a stored information part, which is a part of a data file and is of an information length, from an area or areas of the ROM having a starting address, on the basis of information on the address input by an operator and the information length, which is longer than one bit, input by the operator. The comparing element compares an input information part input by the operator with the stored information part and cancels the read-protection of ROM data when the input information part coincides with the stored information part.

By virtue of the present invention, unless stored information in the ROM and addresses storing the information are known, the read-protection for data cannot be canceled. Therefore, it is extremely difficult to acquire the data file for a third party who does not have proper access authority over the data file. Consequently, it is possible to enhance the security of read-protection of ROM data. In addition, since the information length as a cancellation key is indicated by the operator, the flexibility in use is improved.

### BRIEF DESCRIPTION OF THE DRAWINGS

With reference to the accompanying drawings, various embodiments of the present invention will be described hereinafter. In the drawings,

FIG. 1 is a block diagram showing a ROM-data read-protection-cancellation device according to a first embodiment of the present invention;

FIG. 2 is a block diagram showing a ROM-data read-protection-cancellation device according to a second embodiment of the present invention;

FIG. 3 is a block diagram showing a ROM-data read-protection-cancellation device according to a third embodiment of the present invention; and

FIG. 4 is a block diagram showing a ROM-data read-protection-cancellation device according to a fourth embodiment of the present invention.

### DETAILED DESCRIPTION OF PREFERRED EMBODIMENTS

First Embodiment.

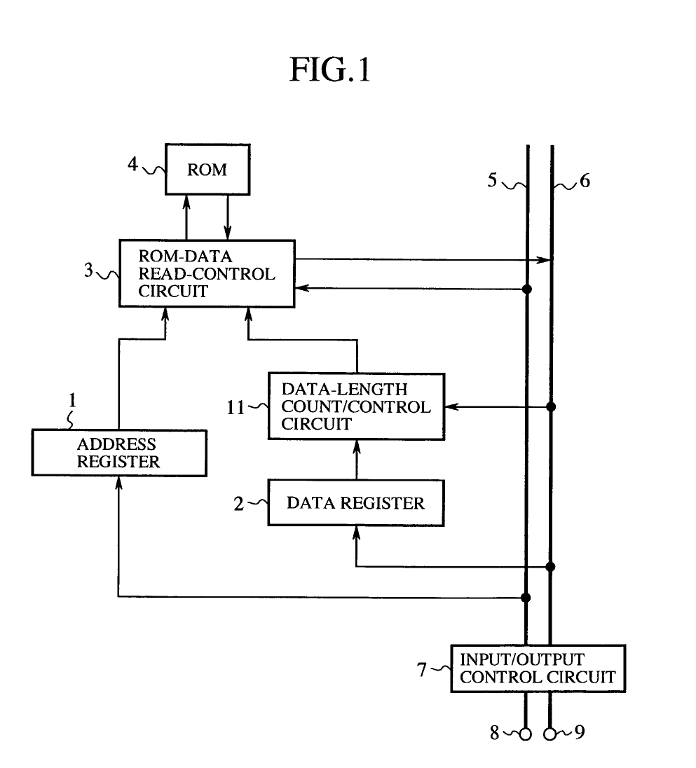

FIG. 1 is a block diagram showing a ROM-data read-protection-cancellation device according to a first embodiment of the present invention. The ROM-data read-protection-cancellation device includes an address register 1, a data register 2, a ROM-data read-control circuit (reading element and comparing element) 3, a ROM 4, a address bus 5, a data bus 6, an input/output control circuit 7, an address input terminal 8, a data input/output terminal 9, and a data-length count/control circuit 11.

The ROM-data read-protection-cancellation device is a part of a microcomputer including other structural elements that do not relate to ROM-data reading although those elements are not illustrated. The input/output control circuit 7 controls flows of signals input to and output from the microcomputer. The input/output control circuit 7 is provided with the address input terminal 8 and the data input/output terminal 9. Signals indicating addresses and data designated by an operator are supplied to the address input terminal 8 and the data input/output terminal 9, respectively. The input/output control circuit 7 supplies signals indicating addresses via the address bus 5 to elements that controls storage devices, e.g., the ROM 4. The input/output control circuit 7 also supplies signals indicating data via the data bus 6 to elements for processing data.

Next, operations of the ROM-data read-protection-cancellation device will be described.

ROM 4 stores program files for controlling operations of the microcomputer and/or other data files that should be stored permanently or semipermanently. The microcomputer includes a processor-mode register (not shown). If a bit or bits stored in the processor-mode register are rewritten, mode of the microcomputer is altered. The microcomputer may operate in read-enable mode and read-disable mode. In read-enable mode, data can be read from the inside ROM 4 by an appropriate manner as will be described later. In read-disable mode, data cannot be read from the inside ROM 4, so that it is unnecessary to protect data stored in the ROM 4 from being read by a third party. However, it is necessary to protect data from being read from the ROM 4 by a third party who does not have proper access authority over data in the ROM 4 in read-enable mode.

Once the microcomputer is set to read-enable mode, the ROM-data read-protection-cancellation device shown in FIG. 1 is automatically set to ROM-protection mode. In addition, the default of the microcomputer is read-enable mode and the default of the ROM-data read-protection-cancellation device is also ROM-protection mode.

After the start of activation of the microcomputer, e.g., after the start of power dispatching, the microcomputer enters read-enable mode and the ROM-data read-protection-cancellation device enters ROM-protection mode for an initial certain period wherein the read-protection of ROM data can be canceled. If the read-protection is not canceled in this mode, then the microcomputer enters read-disable mode wherein the read-protection of ROM data can never be canceled.

During the short period of read-enable mode, the operator who would like to cancel the read-protection of ROM data can input an “address,” an “information length,” and an “input information part” as protection-cancellation keys to the ROM-data read-protection-cancellation device using a man-machine interface. The input information part is a part of the target data file to be read from the ROM 4, and is represented as a bit-code. For example, if a program for controlling an operation of the microcomputer is intended to be read, a part of the program may be used as the input information part. The person, e.g., the manufacturer of a microcomputer or the producer of a program who has proper access authority over data files in the ROM 4 can duly input a part selected from the target data file as the input information part since he or she knows the target data file as a whole. The person who would like to cancel the protection may optionally select any part of his or her target data file as the input information part.

The longer the input information part is, the more preferable in order to prevent the target data file from being read unduly. However, in order to cancel the protection in a short while by a rightful operator, it is preferable that the input information part is shorter. With respect to the first embodiment, the length of input information part is not prescribed. The person who would like to cancel the protection may select the length of the input information part to be one bit or more optionally.

The “address,” which is one of the protection-cancellation keys, is the starting address of the part corresponding to the “input information part” stored in the ROM 4. The person who has proper access authority over data files in the ROM 4 can duly input the correct address since he or she knows the relation between parts of the target data file and the addresses of the parts.

The “information length,” which is also one of the protection-cancellation keys, is the length of the “input information part.”Consequently, the person who would like to cancel the read-protection of ROM data should designate the length (more specifically, the number of bit(s)) of the “input information part” that he or she designates.

The signal indicating the “address” is supplied from the man-machine interface to the address input terminal 8 of the input/output control circuit 7 while the signals indicating the “information length” and the “input information part” are supplied from the man-machine interface to the data input/output terminal 9 of the input/output control circuit 7. The input/output control circuit 7 supplies the signal indicating the address to the address register 1 via the address bus 5, and then the address register 1 holds the information on the address.

The input/output control circuit 7 also supplies the signal indicating the “input information part” to the data register 2 via the data bus 6, and then the data register 2 holds the input information part. Furthermore, the input/output control circuit 7 supplies the signal indicating the “information length” to the data-length count/control circuit 11 via the data bus 6.

The data-length count/control circuit 11 transfers the signal indicating the “information length” to the ROM-data read-control circuit 3. Additionally, the data-length count/control circuit 11 reads the whole or part of “input information part” with a length indicated by the “information length,” and transfers it to the ROM-data read-control circuit 3.

On the basis of the “address” information held in the address register 1 and the signal indicating the information length transferred from the data-length count/control circuit 11, the ROM-data read-control circuit 3 reads from the ROM 4 a “stored information part” that is a part of the target data file stored in the ROM 4. More specifically, the ROM-data read-control circuit 3 reads such a “stored information part” being of the same length with the “information length” from an area or areas of the ROM 4 having the starting address corresponding to the “address” information.

Next, the ROM-data read-control circuit 3 compares the input information part transferred from the data-length count/control circuit 11 with the stored information part. If the input information part is coincident with the stored information part, the ROM-data read-control circuit 3 cancels the read-protection of ROM data. Otherwise, the protection is maintained to be uncanceled.

An example of the cancellation manner of the data-read protection will be described next. The ROM-data read-control circuit 3 may generate a cancellation signal and may transmit it to the input/output control circuit 7. Upon receiving the cancellation signal, the input/output control circuit 7 may be enabled to transfer signals indicating addresses of the ROM 4 from outside to the ROM-data read-control circuit 3. In addition, the ROM-data read-control circuit 3 may rewrite the content of a protection-status register located therein, so as to be capable of accepting signals indicating addresses from the input/output control circuit 7.

In this protection-canceled status, the person who would like to read data from the ROM 4 can designate the starting address and ending address of a data part that he or she would like to read, using the man-machine interface. Once the input/output control circuit 7 receives the signals indicating starting and ending addresses from the man-machine interface via the address input terminal 8, the input/output control circuit 7 transfers the signals to the ROM-data read-control circuit 3 via the address bus 5. Upon receiving the signals indicating addresses, the ROM-data read-control circuit 3 reads from the ROM 4 a series of data part stored in areas defined by the starting address and the ending address. Then, the ROM-data read-control circuit 3 supplies the retrieved data part to the input/output control circuit 7 via the data bus 6, whereby the input/output control circuit 7 sends out the retrieved data part to an outside device from the data input/output terminal 9.

When a plurality of data files are stored in the ROM 4, each data file can be subject to read-protection. Accordingly, only one of those data files having a stored input information part corresponding to an input information part is enabled to be read when the input information part is coincident with the stored information part. The other data files are maintained to be protected.

In order to enhance the security, the number of times of protection-cancellation trials may be restricted. More specifically, if the comparison of the input information part with the stored information part has failed through the predetermined number of trials of comparison, the ROM-data read-control circuit 3 generates a compulsory termination signal and supplies it to an element (e.g., the input/output control circuit 7) within the microcomputer. By the compulsory termination signal, the microcomputer enters read-disable mode wherein the read-protection of ROM data can never be canceled.

As described above, the first embodiment utilizes three protection-cancellation keys: the “address,” “information length,” and “input information part.” Accordingly, unless bits within a target data file in the ROM 4 and addresses storing bits are known, read-protection for data cannot be canceled. Therefore, it is extremely difficult to acquire data files for a third party who does not have proper access authority over data files. If the third part has an LSI tester or similar equipment, the equipment is futile for acquiring the data file. Consequently, it is possible to enhance the security of read-protection of ROM data.

Furthermore, since an optional part of a data file is used for one of protection-cancellation keys, the flexibility in use may be enhanced. For example, since a part of a program file or another data file may be used for a protection-cancellation key, it is unnecessary to store a special protection code in the ROM for switching protection status. Accordingly, the assignment of an area in the ROM for storing such a protection code is not needed, whereby areas in the ROM 4 may be used efficiently.

In addition, since the person may optionally decide the information length, which is one of protection-cancellation keys, the input operation is easy. In addition, if he or she inputs a long input information part that is the same as a whole stored data file such as a program file and the length of the whole data file, it is possible to confirm readily at once whether the contents of the stored data file are faultless or not only by the comparison of the stored information part with the input information part without using a tester.

Furthermore, although some of areas in the ROM 4 where a data file is stored has a damage or another defect or there is an erred bit in the data file, if the person who would like to cancel the protection designates an address of another area avoiding the defective area or erred bit, the comparison of the input information part and the stored information part by the ROM-data read-control circuit 3 may be enabled to cancel the protection. For example, if the ROM 4 becomes defective after a program has been written therein, it is possible to retrieve the program by canceling the protection, so that failure analysis can be made readily.

Second Embodiment.

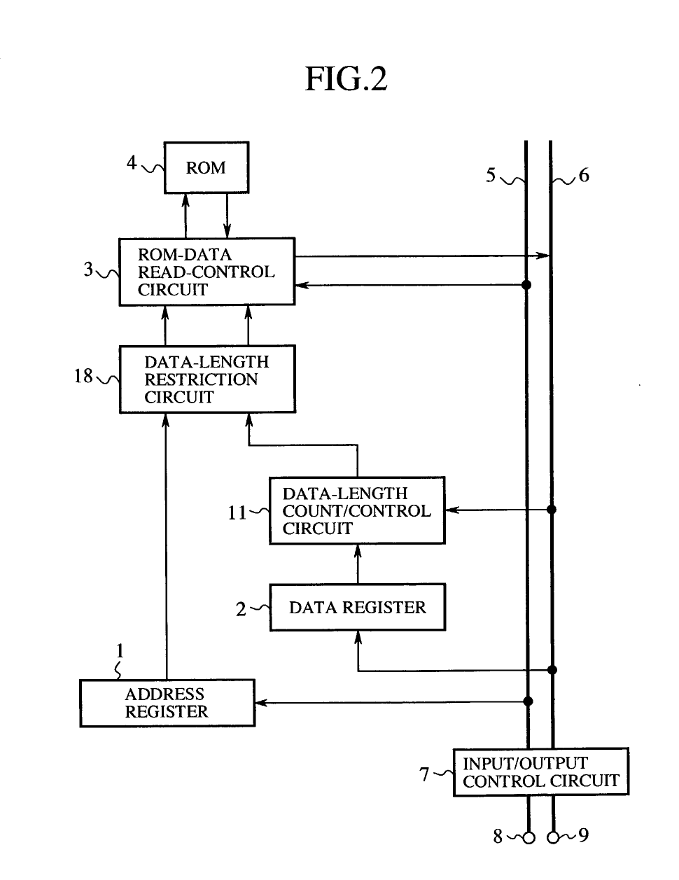

FIG. 2 is a block diagram showing a ROM-data read-protection-cancellation device according to a second embodiment of the present invention. In FIG. 2, reference numeral 18 denotes a data-length restriction circuit (information length restrictor). The second embodiment is similar to the first embodiment except for including the data-length restriction circuit 18.

Next, operations will be described. Since basic operations of the second embodiment are similar to those of the first embodiment, differential operations will be described.

The data-length count/control circuit 11 receives the signal indicating the “information length” from the input/output control circuit 7 via the data bus 6, and transfers the signal to the data-length restriction circuit 18. The data-length count/control circuit 11 reads the whole or part of “input information part” with a length indicated by the “information length,” and transfers it to the data-length restriction circuit 18.

The data-length restriction circuit 18 compares the “information length” with a threshold. If the information length is greater than the threshold, the data-length restriction circuit 18 reads the “address” information from the address register 1, and transfers the “address” information along with the signal indicating the “information length” and the “input information part” to the ROM-data read-control circuit 3. Accordingly, the ROM-data read-control circuit 3 can read the “stored information part” from the ROM 4 on the basis of the address information and the information length, and can compare the stored information part with the input information part.

However, if the information length is equal to or less than the threshold, the data-length restriction circuit 18 does not provide the ROM-data read-control circuit 3 with all or any of the address information, signal indicating the information length, and the input information part. Accordingly, the data-length restriction circuit 18 does not cancel the read-protection of ROM data if the input information part is not longer than a predetermined length.

Such a data-length restriction circuit 18 is provided for preventing a target data file from being read easily with an input information part being of an information length that is too short. For example, if the protection can be canceled with the input information part having one bit in length, the person who would like to cancel the protection has no choice left but to designate zero or one when he or she selects one bit as the information length. Since zero or one is stored at any area in the ROM 4, the protection may be readily broken if cancellation is attempted once or twice. The data-length restriction circuit 18 restricts the information length to more than one bit, so that the security of protection can be enhanced.

In general, the longer the input information part is, the more preferable in order to prevent a data file from being read unduly. For example, if the data-length restriction circuit 18 needs 16 bits or more of input information part, the security of protection can be highly enhanced. However, in order to cancel the protection in a short while by a rightful person, it is preferable that the input information part is not too long.

As described above, the security of protection can be enhanced by virtue of the second embodiment.

Third Embodiment.

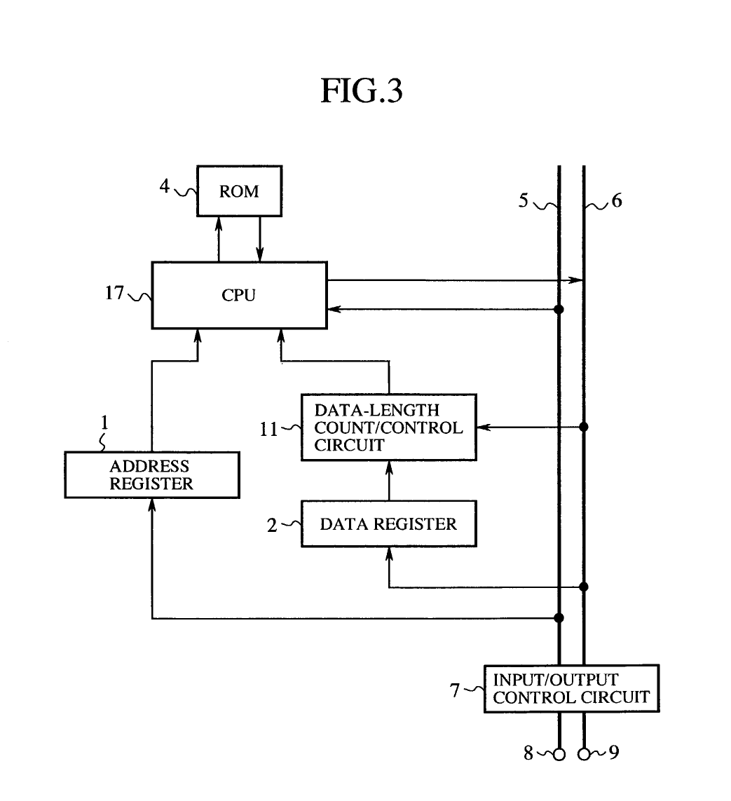

FIG. 3 is a block diagram showing a ROM-data read-protection-cancellation device according to a third embodiment of the present invention. In FIG. 3, reference numeral 17 denotes a built-in CPU (central processing unit) of the microcomputer containing the ROM-data read-protection-cancellation device. In the third embodiment, the ROM-data read-control circuit 3 (FIG. 1) of the first embodiment is replaced by the CPU (reading element and comparing element) 17. Other structural elements and functions thereof are the same as those in the first embodiment.

Operations of the third embodiment can be understood by the description on the operations of the first embodiment when the “ROM-data read-control circuit 3” of the first embodiment is read as “CPU 17” in the description. Accordingly, operations of the third embodiment will not be explained in detail.

CPU 17 is not a special element for the ROM-data read-protection-cancellation device, but is provided inherently for the entire organization of the microcomputer including the ROM-data read-protection-cancellation device. Since the ROM-data read-control circuit 3 is replaced with the CPU 17, increase in the volume and area of the microcomputer can be restricted or minimized.

As described above, the third embodiment not only enhances the security of the protection and the flexibility in use, but also restricts in the volume and area of the microcomputer.

Fourth Embodiment.

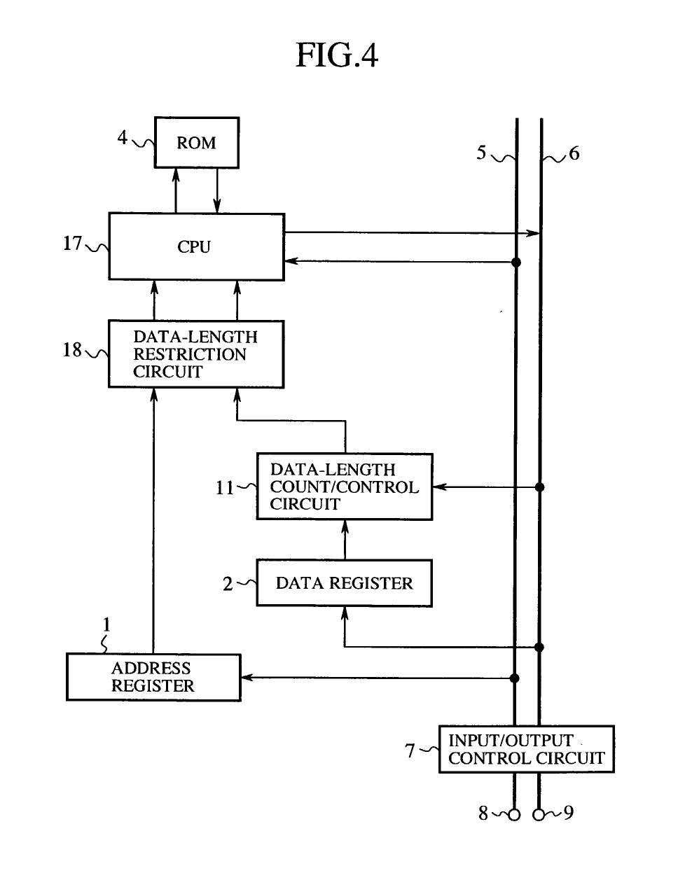

FIG. 4 is a block diagram showing a ROM-data read-protection-cancellation device according to a fourth embodiment of the present invention. In the fourth embodiment, the ROM-data read-control circuit 3 (FIG. 2) of the second embodiment is replaced by the CPU 17. Other structural elements and functions thereof are the same as those in the second embodiment.

Operations of the fourth embodiment can be understood by the description on the operations of the second embodiment when the “ROM-data read-control circuit 3” of the second embodiment is read as “CPU 17” in the description. Accordingly, operations of the fourth embodiment will not be explained in detail.

CPU 17 is not a special element for the ROM-data read-protection-cancellation device, but is provided inherently for the entire organization of the microcomputer including the ROM-data read-protection-cancellation device. Since the ROM-data read-control circuit 3 is replaced with the CPU 17, increase in the volume and area of the microcomputer can be restricted or minimized.

As described above, the fourth embodiment not only enhances the security of the protection and the flexibility in use, but also restricts in the volume and area of the microcomputer.

While the present invention has been particularly shown and described with references to preferred embodiments thereof, it will be understood by those skilled in the art that various changes in form and details may be made therein without departing from the spirit and scope of the invention as defined by the claims. Such variations, alterations, and modifications are intended to be encompassed in the scope of the claims.

What is claimed is:

1. A ROM-data read-protection-cancellation device, which cancels read-protection of ROM data if an operator knows an information part stored in a ROM correctly, comprising:
a reading element for reading a stored information part, which is a part of a data file in the ROM and is of an information length, from an area or areas of the ROM having a starting address, on the basis of information on the address input by an operator and the information length, which is longer than one bit, input by the operator; and
a comparing element for comparing an input information part input by the operator with the stored information part and for canceling the read-protection of ROM data when the input information part coincides with the stored information part.

2. The ROM-data read-protection-cancellation device according to claim 1, further comprising an information length restrictor for comparing the information length input by the operator with a threshold and for maintaining the read-protection of ROM data uncanceled when the input information length is equal to or less than the threshold.

3. The ROM-data read-protection-cancellation device according to claim 1, wherein the reading element accepts a signal indicating the starting address in the ROM input by the operator optionally, and reads the stored information part on the basis of the input starting address.

4. The ROM-data read-protection-cancellation device according to claim 1, wherein the reading element and the comparing element comprises a CPU in a microcomputer including the ROM-data read-protection-cancellation device.
